(19) United States
(12) Patent Application Publication
(10) Pub. No.: US 2017/0259608 A1
(43) Pub. Date: Sep. 14, 2017

(54) Metal Greeting Card

(71) Applicant: Candace Pearl McGinn, Encinitas, CA (US)

(72) Inventor: Candace Pearl McGinn, Encinitas, CA (US)

(21) Appl. No.: 15/458,866

(22) Filed: Mar. 14, 2017

Related U.S. Application Data
(60) Provisional application No. 62/307,522, filed on Mar. 13, 2016.

(51) Int. Cl. B42D 15/00; B44F 7/00; B42D 15/02

(52) U.S. Cl. CPC B42D 15/0093; B42D 15/02; B44F 7/00

(57) ABSTRACT

Art meets technology in this invention of a Metal Greeting Card. Combining the technology of sublimation on metal, and artful images and greetings of all kinds, this invention creates a luminescent metal greeting card that can stand the test of time, as it will withstand exposure to the elements. Metal Greeting Card gives the sender and receiver, both, the reassuring feeling that their thoughts and sentiment expressed by the card, will last exponentially beyond the life span of a paper card. Because the Greeting Card is made of a single sheet of metal, and has been determined by the U.S. Postal Service as approved to send through the mail, with or without an envelope, and that it will last longer than paper, makes it superior to its predecessors, paper and mixed element/paper greeting cards. It is simplicity in form; one piece of metal, two-sided with an image on one side and a greeting or note on the other side, yet it is technologically complex using the sublimation process on metal. This metal greeting card delivers an iridescent and beautiful greeting and can be displayed as one would any piece of art.

### CROSS-REFERENCE TO RELATED APPLICATIONS

This invention claims priority to and the benefit of U.S. Provisional Patent Application No. 62/307, filed Mar. 13, 2016; Expired.

### STATEMENT REGARDING FEDERALLY SPONSORED RESEARCH OR DEVELOPMENT:

Not Applicable

### THE NAMES OF THE PARTIES TO A JOINT RESEARCH AGREEMENT

Not Applicable

### REFERENCE TO A SEQUENCE LISTING

Not Applicable

### STATEMENT REGARDING PRIOR DISCLOSURES BY THE INVENTOR

This invention claims priority to and the benefit of U.S. Provisional Patent Application No. 62/307, filed Mar. 13, 2016.

### BACKGROUND OF THE INVENTION

Sending greeting cards has been a time-honored way to enhance our relationships with others. Greeting cards have been a way to express our thoughts and feelings to others, using images and the written word. The greeting card industry currently has cards that are made with some sort of paper, in many forms, ie., thick paper, cardboard, cards with a combination of some other material AND paper. There are no cards purely made of metal. The cards of paper have a short life, and as such, any type of natural element can easily do-away with them, ie., water, fire, light, time, etc. These paper cards, or combination thereof, are easily destructible.

### SUMMARY OF THE INVENTION

There are existing problems with paper Greeting Cards, in that one takes such time and care to express themselves in a heart-felt way to their recipient, and yet, in a moment, the paper card can be destroyed by a light of a match, or drips of water, or a crumpling of the paper and the yellowing of it with time and exposure to light.

Metal Greeting Cards, because they are metal, have a lasting quality, and as such, elements of a lit match, water drips and crumplings, would not affect the metal. In fade tests, the sublimated Metal Greeting Card lasted two to four times longer than the leading photo papers, and there is no need to protect it under glass. Due to the tough sublimation coating, the treated metal is also scratch resistant, stain resistant, waterproof, fire resistant, tear resistant, impervious to damage from tape or glue, and will not yellow with age.

### DESCRIPTION OF DRAWINGS

FIG. 1

This Photograph shows a blank piece of raw metal with square corners. Both sides of the blank piece of raw metal look like this. This is what is used to create the Metal Greeting Card.

FIG. 2

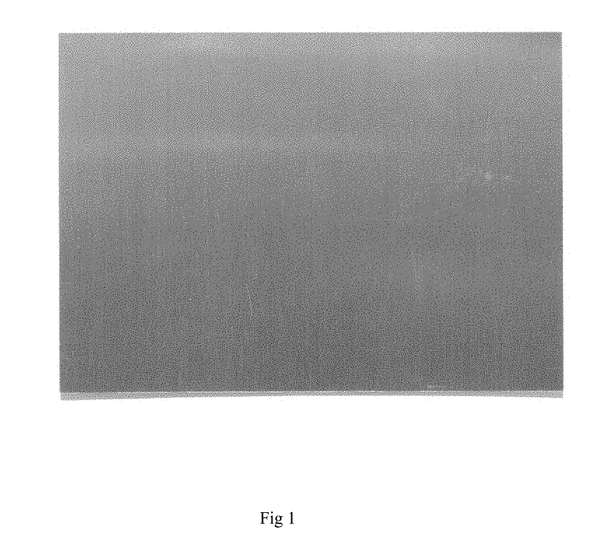

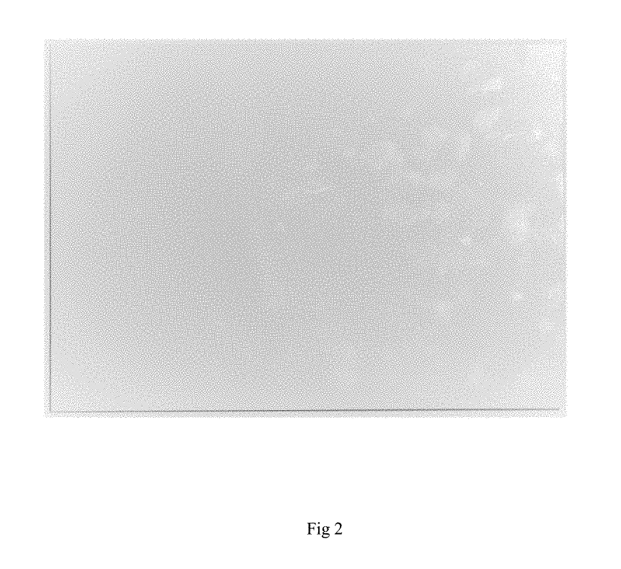

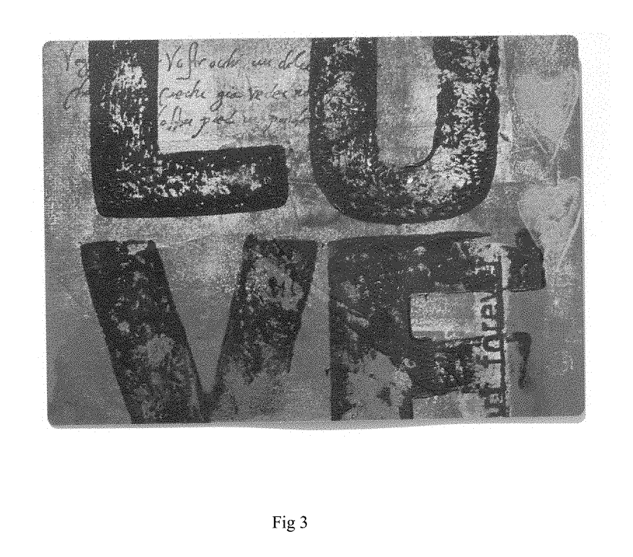

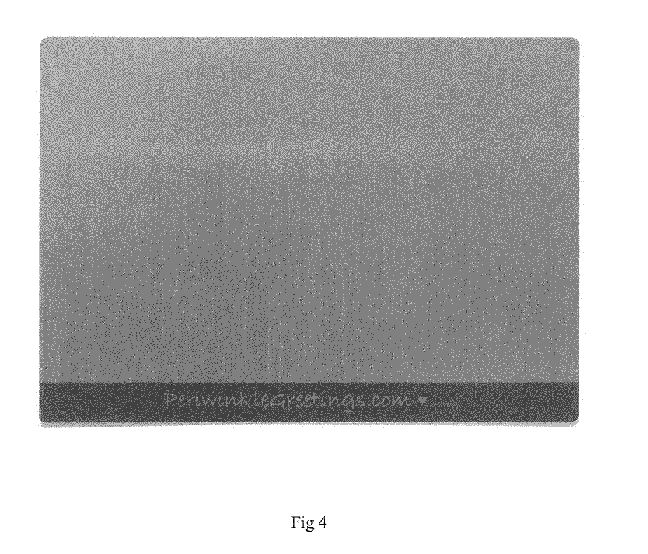

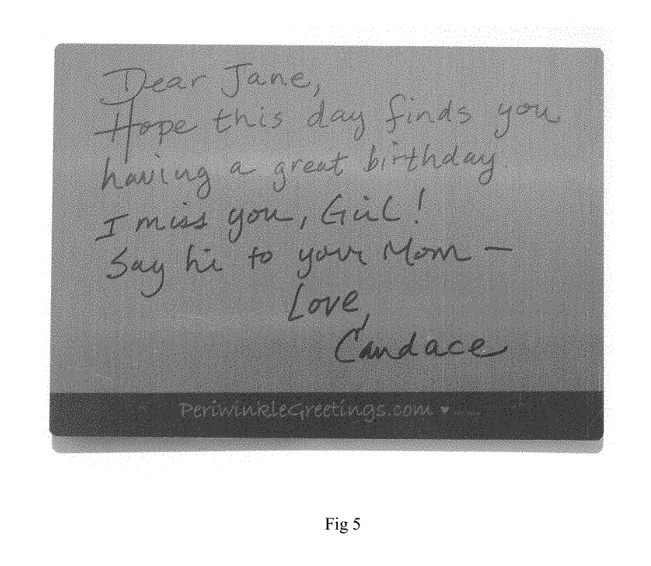

This photograph shows the blank piece of metal with square corners, as in FIG. 1, but now with a special coating on one side, as shown. We call this side of the metal piece, “The Front”. The other side of this piece of metal has no coating. We call the side with no coating, “The Back”. The coating on The Front, as shown, is prior art. The coating, placed on the metal, is what is needed to allow the sublimation process to take place, and accept the image into the metal by using a heat process called sublimation. The sublimation process is prior art, and is being used in this invention. The explanation of this prior art, the “sublimation process” is described in detail in the SPEC, under “DETAILED DESCRIPTION OF THE INVENTION”.

FIG. 3

This photograph shows The Front of the metal piece; now with an image printed onto and into the metal, using the sublimation process, as described in detail in the SPEC, under “DETAILED DESCRIPTION OF THE INVENTION”.

Also shown and to be noted; the corners are now rounded. This is done to comply with the U.S. Postal Service requirements for a mail piece to be sent through the mail, as stated in the SPEC, in the “DETAILED DESCRIPTION OF THE INVENTION”.

FIG. 4

This photograph shows The Back of the Metal Greeting Card. The back has no special coating. The area of metal is left mostly blank for writing a message by the sender. This Metal Greeting Card photograph shows an example of the name of the company that printed the card. The printing in this example was done without using the sublimation process.

FIG. 5

This photograph shows The Back of the Metal Greeting Card, and now with an example of a message written on it. In this example, an indelible ink pen was used. This Metal Greeting Card may be inserted into an envelope and given to a recipient or it may be mailed. In mailing the Metal Greeting Card, the envelope must meet postal requirements.

### DETAILED DESCRIPTION OF THE INVENTION

The trend of the paper greeting card industry, currently, has shifted. Because of new technology, it is so easy to send a greeting electronically, and eliminate sending a paper card through the mail. The greeting card industry is struggling to stay relevant in the digital age. Yet it is the using of new technologies, that the Metal Greeting Card has been invented. The Metal Greeting Cards are created by using newer technology called “Sublimation”. This allows a vibrant image on the card, after the image is infused into the metal, and is unlike what any printed image looks like on paper. This exciting invention will stimulate the struggling greeting card industry, as the invention is a stupendous and stunning visual; a piece of art, and which can be displayed as such.

Explicitly, the metal used is specific in that the metal itself, must have a special coating on at least one side; A “sublimation coating”. An example of such coating: a clear/white polyester paint/coating, which will accept sublimated gas, and pick up and hold a transferred image; the image is infused into the metal through the sublimation process.

“Sublimation” means going directly from solid to gas without the middle step of liquid. The best-known example of sublimation is dry ice, which goes from a solid directly to carbon dioxide gas without ever getting wet. The sublimation coating process is sort of an “iron-on coating”. One prints an image onto a special heat transferring paper, using special dyes in an ink-jet printer, press it against the metal piece with the sublimation coating, and apply heat. The dyes/inks that are used in the inkjet printer, sublimate, i.e., turn to gas, and are infused into the surface of the metal.

The sublimation process used on the one side to create a beautiful picture or even a custom picture, are levels above an average photograph, or drawing on paper, as the luminescence that the metal takes on through this sublimation process to infuse the picture into the metal, is beyond compare. The metal takes on a glossy luminescence through the sublimation process, when the ink/dye is infused into the metal, it gives the metal unparalleled color vibrancy with an intriguing color depth and a 3D look.

The thickness of the Metal Greeting Cards used is a gauge that satisfies both the consumer and the U.S. Post Office.

The concept of sublimation printing has been around since the late 1950's, yet it is only because of the evolution of this process that has allowed for today's invention of the Greeting card in such a remarkable way. It wasn't until 1989, with “Established thermal head heat control technology and dye-sublimation printing technology”, that there was available, a “Released full-color A3 dye-sub printer for color proofing”. To sum up this invention and its creation, the invention brings new elements and technology together, to create the new generation of Greeting Cards. The paper greeting card industry has no need to take the step to use the sublimation process, as the cost is prohibitive using only paper, as paper is so destructible.

This Metal Greeting Card is one piece of metal, having two sides. Using the Sublimation Process, named above, the side with the special coating becomes a luminescent greeting card, as an image is transferred and infused, with ink/dyes, into the metal. On the other side, the metal maintains itself and can be printed on or written on with an indelible pen or marker. It is the duller side of the (metal) card, yet a very important part, as it can carry a personally written message from the sender to the recipient.

The U.S. Postal Service has given authority to the invention of Metal Greeting Cards as acceptable to send through the mail, as these cards meet the requirements in “The Domestic Mail Physical Standards of Letters”, which states, beginning at” 1.0 Physical Standards for Letters”:
“ 1.0 Physical Standards for Letters
1.1 Dimensional Standards for
Letters Letter-size mail is:

a. Not less than 5 inches long, 3½ inches high, and 0.007-inch thick.

For pieces more than 4¼ inches high or 6 inches long, or both, the minimum thickness is 0.009.

b. Not more than 11½ inches long, or more than 6⅛ inches high, or more than ¼-inch thick.

c. Not more than 3.5 ounces (First-Class Mail letter-size pieces over 3.5 ounces pay flat-size prices).

d. Rectangular, with four square comers and parallel opposite sides. Letter-size, card-type mailpieces made of cardstock may have finished comers that do not exceed a radius of 0.125 inch (⅛ inch). See Exhibit 201.1.1.1.

1.2 Nonmachinable Criteria

A letter-size piece is nonmachinable if it has one or more of the following characteristics (see 601.1.1.2 to determine the length, height, top, and bottom of a mail piece):

a. Has an aspect ratio (length divided by height) of less than 1.3 or more than 2.5.

b. Is polybagged, polywrapped, enclosed in any plastic material, or has an exterior surface made of a material that is not paper. Windows in envelopes made of paper do not make mail pieces nonmachinable. Attachments allowable under applicable eligibility standards do not make mail pieces nonmachinable.

1. There is currently no known article solely made of metal that claims to be a Metal Greeting Card.

2. Metal Greeting Card invention is made of metal, having two sides; One side for the image, one side for the message.

3. The invention uses a sublimation process, on at least one side of the piece of metal, with a special coating, in which a vibrant, 3-D-like luminescent image is created.

1. Metal Greeting Card invention, has a longer life than greeting cards that are made of paper, as metal inherently lasts longer than paper.

2. Metal Greeting Card invention adheres to the “U.S. Domestic Mail Physical Standards of Letters” and can be sent through the mail.
